(19) United States
(12) Patent Application Publication
(10) Pub. No.: US 2016/0379256 A1
(43) Pub. Date: Dec. 29, 2016

(54) METHOD AND SYSTEM FOR INTEGRATING DEVICE ACTIVITY AND PURCHASE TRANSACTION DATA TO ASSESS AND/OR PREDICT CONSUMER INTEREST

(71) Applicant: Perk.com US Inc., Austin, TX (US)

(72) Inventors: Adam Salamon, Austin, TX (US); Surojit Niyogi, Austin, TX (US)

(73) Assignee: Perk.com US Inc.

(21) Appl. No.: 15/196,032

(22) Filed: Jun. 29, 2016

Related U.S. Application Data
(60) Provisional application No. 62/186,134, filed on Jun. 29, 2015.

(51) Int. Cl. G06Q 30/02

(52) U.S. Cl. CPC G06Q 30/0255; G06Q 30/0269

(57) ABSTRACT

A method is disclosed that causes a computer application to be downloaded onto a user device to track performance of a predetermined action toward offering the end user a discrete incentive for performing that predetermined action. The disclosed method further includes populating a database with demographic and payment information about the end user and receiving action data from the computer application that identifies the user device and the predetermined action. The method further obtains and stores payment transaction data associated with the payment information of the end user, such that the server can correlate at least a portion of each of the end user demographic information, the end user action data, and the end user payment transaction data on an end user by end user basis toward creating content based on the correlation. A system for meeting similar needs is also disclosed.

### CROSS REFERENCE TO RELATED APPLICATION

This application claims priority to U.S. Provisional Application Ser. No. 62/186,134, filed Jun. 29, 2015, the entirety of which is incorporated herein by reference.

### FIELD OF THE INVENTION

The disclosed embodiments relate to and provide methods, systems and/or applications for integrating a user's device activity with purchase transaction data toward assessing and/or predicting consumer interest.

### BACKGROUND

A great deal of time, energy and money is spent on trying to persuade consumers to purchase goods and services, play games and/or use their mobile and other devices in a particular manner through advertising and other incentive-based techniques. However, there is no solution available to track data based on these techniques and improve on a per user basis the effectiveness of these advertising techniques on a consumer's future behavior.

It would be particularly useful to have a system and/or method capable of assessing and/or predicting the effectiveness of certain advertising on consumer purchasing behavior at a transaction level. It would be further desirable if that system and method could assess and/or predict the payment method that a consumer will use in purchasing. It would be additionally useful to correlate any relationship between predetermined activities (e.g., playing games, watching videos, accessing a website, etc.) performed on the user's device and purchasing decisions. If any of the foregoing could be provided on a user by user basis, the utility would be even greater.

Accordingly, there is a need and desire to integrate a user's device activity with purchase transaction data.

### SUMMARY

In one embodiment, the disclosed embodiments relate to and provide the integration of purchase transaction and advertising data (where “advertising data” refers to data associated with advertising and incentive-based offers). The innovations described herein link a commercial or other purchase transaction to user activity in a manner that allows for the measurement and improvement of the advertising effectiveness on the consumer's behavior. For example, the disclosed principles can track that a product purchased using e.g., a credit card, debit card, cash, or other payment method, was based on an online/mobile advertisement or other form of incentive viewed/acknowledged on a smartphone or other user computing device. Users may be incentivized through a direct reward to link their payment platform information to their device(s) or through a direct reward to upload a picture of their receipt (e.g., for cash purchase transactions) and for actions related to allowing measurement of the effectiveness of advertising or incentive-based offers, to name a few.

In one embodiment, the disclosed principles provide a method of associating advertising activity with user device activity. The method comprises receiving, at a server computer, data associated with the user device activity, the data being received over a network connection; receiving, at the server computer, data associated with the advertising activity, the data being received over the network connection; and correlating, by a processor of the server computer, the data associated with the user device activity to the data associated with the advertising activity to measure an effectiveness of the advertising activity.

### BRIEF DESCRIPTION OF THE DRAWINGS

FIG. 1 illustrates an exemplary implementation of the disclosed principles.

FIG. 2 illustrates an exemplary implementation of database 185.

FIG. 3 illustrates an exemplary logic flow diagram of the disclosed principles.

FIG. 4 illustrates another exemplary implementation of the disclosed principles

### DETAILED DESCRIPTION

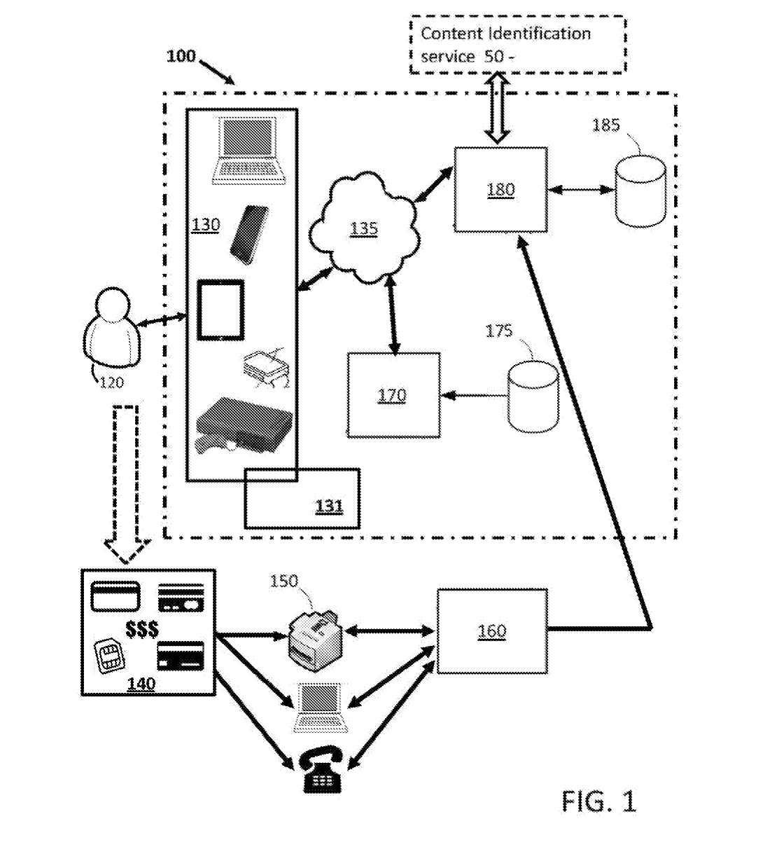

FIG. 1 illustrates a system 100 according to a first exemplary implementation of the disclosed principles. An end user 120 is logically associated with payment information 140 which may include, for instance, payment platforms (e.g. credit card(s), debit cards, electronic payment systems, virtual currency), The end user 120 may be logically associated with the payment information 140 by unique identification information, such as Primary Account Numbers (“PANs”), particular blockchain(s), and/or secure element ID. The end user 120 is also associated with user device 130, which may be, for example, a desktop or portable computer, a mobile phone, a tablet, a wearable device, or interactive television receiver.

The system 100 may be associated with one or more transaction servers 160 that record purchase transactions associated with one or more payment platforms. As illustrated in FIG. 1, the transaction server 160 may receive transactions from a transaction terminal 150 that may be any type of device for completing a purchase transaction using the payment information 140. As further illustrated in FIG. 1, transaction server 160 may receive transactions from a computer (which may, in some embodiments, double as user device 130) or even a telephone order.

The user device 130 of system 100 may be any electronic device operably associated with end user 120 configured to facilitate the performance of one or more actions under the operation of the end user 120 in conjunction with one or more computer applications 131 and further configured for bidirectional communication over at least a first data network 135, such as the Internet, and perhaps a second data network (not shown), such as a cellular telephone system. In particular, where user device 130 is a mobile phone (e.g. a smartphone which may be iOS-based, Android-based, or Microsoft Mobile-based) or personal digital assistant (“PDA”), the user device 130 will include subsystems for connecting to the second data network. The second data network may be used in association with the system 100, where necessary. Where the user device 130 is a wearable device it can be, for example, a prosthetic attached to a user, a smartwatch, earphones, headphones, health tracker, step counter, GPS device, body monitoring system, glasses, contacts and articles of clothing including sensors and processing capable of detecting and acknowledging an advertisement. The wearable devices may be, for instance, worn by a user, permanently or removably attached to a body, worn as clothing or an accessory, or within a predetermined proximity to a user and may include any device that functions as an addition or extension to the human body. In some embodiments, the wearable device may include a chip embedded within an article of clothing, embedded within the human body, or embedded within an accessory worn by the user.

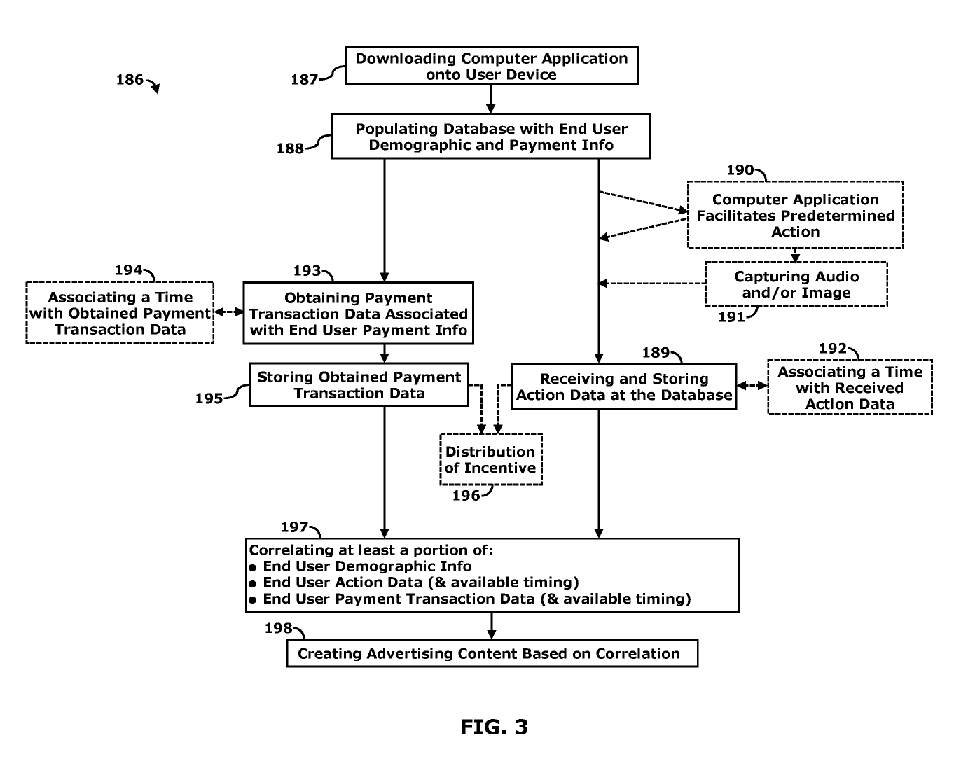

The exemplary illustrations of the system and method are implemented using a computer application 131 that can be downloaded (or preloaded) onto user device 130. Where the computer application 131 is preloaded, such preloading is done under the instruction of the system supplier to ensure operability of the user device 130 within system 100. In general, computer application 131 will cause the user device 130 to interact with the server computer 180 over the first data network 135 or the second data network to perform the method which will be described more fully herein in association with FIG. 3. In particular, the computer application 131 will note that a predetermined action is performed on the user device 130 and transmit data, for instance, using the first data network 135 or the second data network regarding the action (i.e. action data) to a database 185 operably associated with server computer 180. In this way, the computer application 131—in association with the server computer 180—may offer the end user 120 a discrete incentive or reward for performing the predetermined action. Rewards (e.g., discount coupons, gift cards, cash, currency, free items and virtual goods, videos, access to premium content, the unlocking of features to a website or other service, or various forms of vouchers or loyalty points that can be exchanged for any of the foregoing) are distributed upon recognition that the predetermined action was performed on the user device 130. Rewards may be distributed physically or digitally. By way of non-limiting example, upon receipt of the action data indicating that the predetermined action was performed, the system 100 may be configured to cause the server computer 180 to send a signal over the first data network 135 to the application 131 on the user device 130 designed to unlock access to premium content making it available for use by the end user 120 on the user device 130.

The action data identifies the user device 130 that transmitted the action data as well as the predetermined action that was performed. By way of non-limiting example, the predetermined action may include one or more of the following actions: downloading the computer application 131 onto the user device 130, making a purchase using the user device 130 (e.g. via a web browser or a purchasing application), playing a game, capturing an image of a receipt corresponding to a purchase, watching at least a predetermined amount (i.e. greater than a few milliseconds) of a video, listening to at least a predetermined amount (i.e. greater than a few milliseconds) of a program, accessing a website, participating in a survey, acknowledging receipt of particular electronic content, taking a photo, and taking a video.

Where the predetermined action calls for capturing an image, the user device 130 must have an image capturing device (i.e. a camera). It is contemplated that the captured image may be validated by determining the location of the user device 130 at the time of the image capture where the user device 130 provides such functionality. Accordingly, where location determination is available it may be accomplished using any of a variety of location determining approaches including, but not limited to GPS based approaches, cell tower triangulation approaches, location identification beacons, and combinations of those approaches. The captured image may contain a code, such as a QR code, to aid in determining the identification of the image captured. Among the images that may be captured are receipts associated with purchases made by the end user 120 using one of the payment forms reflected by payment information 140. The action data captured and transmitted by the computer application 131 in association with an image capture would include information about the image and/or embedded QR code and, where available, the time and location of the image capture.

Similarly, where the predetermined action is listening to at least a predetermined amount of a program (e.g. 10 seconds, 10 minutes, 6 hours, etc.), the user device 130 must have a microphone and the computer application 131 must be capable of capturing information related to the audio captured via the microphone. In this example, the action data transmitted to the server computer 180 for storage in the database 185 includes data associated with the captured audio from the program and, where available, the time and location of the audio capture. From the audio information, the program associated with the captured audio can be identified. Where the program is a show, a movie, an advertisement, or the like, identifying information is stored in a database, such as database 185 in association with the associated action data. In particular, server computer 180 may obtain this identifying information by passing data to a content identification service 50 such as Gracenote or Shazaam. In response, the content identification service 50 returns information regarding the content such as title, genre, length of overall content, performers associated with the content. For advertisements, the content data describes the product name and genre.

In some exemplary implementations of the system 100, the computer application 131 provides the capabilities necessary to perform the predetermined action. For example, the computer application 131 may provide a user interface (not shown) for audio or image capture. Moreover, the user interface of the computer application 131 may offer the end user 120 a discrete incentive for performing the predetermined action. For instance, let's say a billboard advertising company was interested in learning about the type of people that see one or more particular billboards. The computer application 131 may display a message to the end user 120 informing them if they capture an image of a particular billboard advertisement for an automobile they will be rewarded points sufficient to obtain a $5 dollar gift card for coffee.

In another example, the computer application 131 may be provided with games and playing these games fulfills the predetermined action required. For instance, playing five minutes of a game such as, for instance, a driving simulation, board game, word jumble, etc. may result in the rewarding of points. In yet another example, the computer application 131 may be provided with an internet browser. In this example, searching via the internet browser for a predetermined amount of time (i.e. 15 minute intervals) may result in the rewarding of points. In each of these non-exclusive examples, the possibility of point rewards that can later be exchanged for goods or services motivates the end user 120 to participate in the activity. It is not necessary to continually advise the end user 120 of the opportunity to be awarded points for continuing interaction with the user device 130. It should also be understood that instead of awarding points for later redemption for goods/services, etc. it would be possible to directly reward the end user 120 for each predetermined action. Moreover, it is also contemplated that repetitive performance of a predetermined action may result in enhanced rewards.

In some implementations, end users 120 may be incentivized through a direct reward to link their payment information 140 to their user device(s) 130 to encourage the tracking of advertising effectiveness. Once linked, the system 100 may target or re-target the end user 120 with advertising specific to the end user 120 that is relevant and more effective in encouraging end user 120 purchases.

In some exemplary implementations of the method and system, the computer application 131 may also track actions that are not predetermined. In this implementation, the computer application 131 would capture and transmit to the server computer 180 information regarding any action accomplished via the user device 130. The server computer 180 may save those actions in the database 185 or it may simply count how many non-predetermined actions are being tracked and then discard the action data associated with the non-predetermined action. The abstract number of tracked non-predetermined actions may be used to determine a specific discrete incentive for performing the actions.

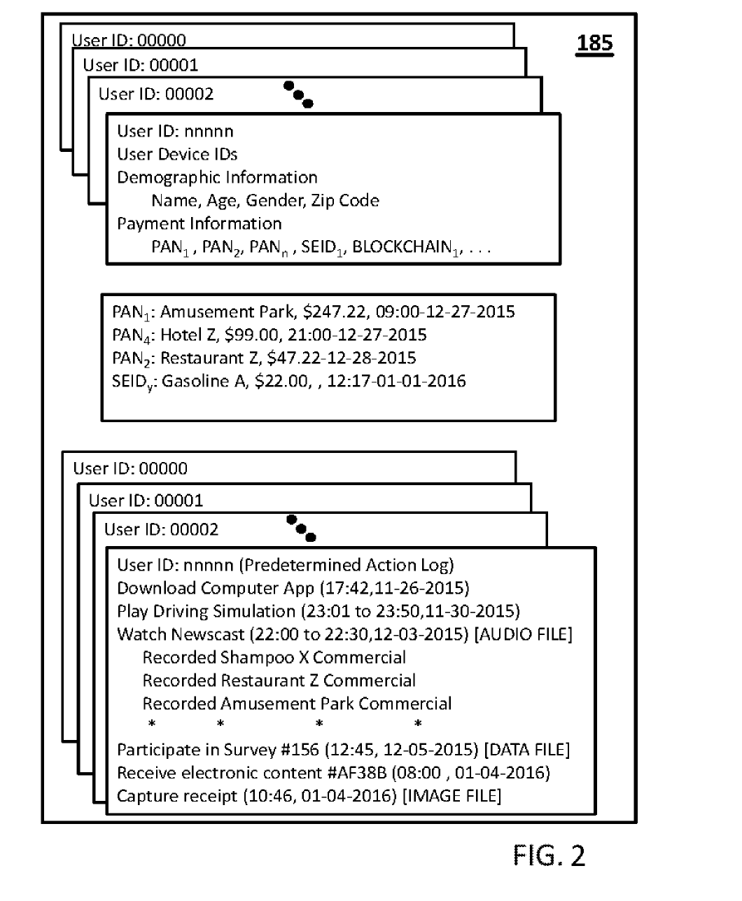

As illustrated in FIG. 2, database 185 stores all of the action data provided by computer application 131. In this exemplary illustration, database 185 is a relational database that stores not only the action data for each end user 120, but also the demographic and payment information 140 for each end user 120, as well as payment transaction data which may be obtained from the transaction server 160. Although database 185 is illustrated as a single logical database, it is contemplated that the information in system 100 may be stored in separate logical databases instead of a single database. Similarly, each database(s) 185 may be distributed across a plurality of storage devices, otherwise duplicated to provide system redundancies and for potential load balancing. Each database(s) 185 may also be regularly backed up.

Returning to FIG. 2, database 185 is illustrated as containing user demographic data, such as the name, age, gender, and zip code of each end user 120. The database 185 also includes identification for each user device 130 associated with a particular end user 120. As illustrated, each end user 120 is assigned a unique user ID by the system 100. This unique user ID may be used as the key that relates the various records across the database 185 (as illustrated).

The database 185 also includes payment information 140 of each end user 120. The payment information 140 is not particularly limited and may be credit card or debit card information, which is illustrated with the term PAN (primary account number). Preferably, the actual number saved in the database 185 is not the true PAN of the end users. Rather, wherever possible system 100 will use a tokenized referenced to an end user's PAN. This token is preferably generated by the payment company before they transmit purchase data to the system 100. In other words, the data received from transaction server 160 will be tied to a tokenized version of the end user's PANs. Payment information 140 could include scanned images of receipts for e.g., cash and other purchase transactions not made through the transaction server 160. The payment platform from which the payment information 140 is derived may be any electronic payment system, mobile payment solution, virtual currency, and any payment platform including user purchase transaction data, including cash transactions that have a receipt that has been emailed, printed, uploaded, scanned, and/or electronically formatted. For example, payment information 140 can be from an electronic payment service such as PayPal.

According to one implementation, a payment solution (debit/credit or otherwise) is tied to an end user 120 and user account. For example, an end user 120 may login to sign-up for a debit card, where the account associated with the card collects purchase transaction data on purchases made using the card. Separately, the end user 120 may login with the same account on their user device 130. The data associated with both purchase transaction and user device 130 activities may be stored (shopping and digital activities) associated with the end user 120 user account.

In the illustration of database 185 in FIG. 2, each end user 120 has a record of action data. This action data will generally record predetermined actions (e.g. download computer application, play game, capture audio from television/radio programming), but it is contemplated that the system 100 may record non-predetermined actions and may also store those actions in the database 185. As illustrated, the action data may include the relative time (e.g. 17:42, Nov. 26, 2015) and elapsed time (e.g. 23:01 to 23:50) for an action. The action data may include operable links to files, such as an audio, data, or image file associated with the particular action data. (The files may be stored elsewhere or in the same storage as the database 185.) Moreover, the server computer 180 may use the records associated with each end user 120 to provide derivative data. As shown in the illustration of FIG. 2, the server computer 180, in conjunction with a content identification service 50, was able to determine the commercials recorded (and likely observed by end user “nnnnn”) during the Newscast on Dec. 3, 2015, using the audio file. In particular, end user “nnnnn” likely saw a commercial for Shampoo X, Restaurant Z, and the Amusement Park on Dec. 3, 2015

The database 185 illustrated in FIG. 2 further includes payment transaction data obtained from transaction server 160. This data is illustrated as not segregated on an end user 120 by end user 120 basis. However, it would be possible to distribute payment transaction data to the record of each end user 120 as it is received by the system 100. Returning to the illustrated example, we can see two transactions related to Payment Information 140 associated with end user “nnnnn”:
PAN₁: Amusement Park, $247.22, 09:00-Dec. 27, 2015
PAN₂: Restaurant Z, $47.22-Dec. 28, 2015
   It is understood that these transactions are related to the particular end user “nnnnn” because they are transactions conducted using credit/debit cards having primary account numbers: PAN₁ and PAN₂ which also appear in end user “nnnnn”'s user data. The data illustrated is at a merchant level (e.g. Amusement Park). It is contemplated that to the extent such data could be obtained, the payment transaction data could be SKU level data. SKU level data could be obtained, for instance, from image captures of paper receipts. In fact, payment transaction data may be manually input by the end user 120 by scanning, photography, printing, mailing, and otherwise communicating payment transaction data from a receipt to the system 100. In this manner, any payment transaction data, be it based on a payment platform or cash may be tracked and linked with advertising data for each end user 120.

By tying both purchase transactions and action data to a unique identifier, the innovations presented herewith tie purchase transactions of the end user 120 to their digital behavior patterns such as web traffic, mobile app traffic, and other data accessed or received by the user device 130. In this manner, advertising, for example, for a particular end user 120 may be targeted and refined in a granular fashion based on shopping behavior across the spectrum of retailers using any type of payment information. Advertisements and/or incentive offers may be generated, tracked and transmitted by an advertising server 170 (FIG. 1).

As further illustrated, database 185 is operated in conjunction with server computer 180. Server computer 180 is operably connected to database 185, advertising server 170 (and thus, an advertising database 175 operably associated with advertising server 170), transaction server 160, a plurality of user devices 130, and content identification service 50. Although particular connections are illustrated in FIG. 1 as being either via the first data network 135 or direct, it should be understood that all of the elements may be connected in a point-to-point fashion just as all the elements may be connected via a wide-area network, such as the Internet. Of course, where payment transaction data is concerned, the system 100 would employ security measures in transmission and storage of this sensitive data.

Server computer 180 is general purpose computer that includes or is operably associated with non transitory memory for storing computer instructions required to implement the methods described herein and to store the various databases, user information and login/account verification algorithms used during the above-described processes. The server computer 180 can be operably associated with input/output devices, such as a mouse, a keyboard, displays, scanners, and/or printers (not shown). In one embodiment, the above described system 100 is implemented in software (i.e., computer instructions) that are stored in a tangible computer readable non transitory memory and executed by at least one processor. Below is a description of a set of non-limiting use cases of the disclosed principles.

In addition to managing database 185, server computer 180 correlates at least a portion of each of the end user demographic information, the end user action data, and the end user payment transaction data on an end user 120 by end user 120 basis to assess or otherwise predict consumer interest. Where available, the server computer 180 may also correlate consumer interest further by looking for a temporal relationship between the advertisement and the obtained payment transaction data. In the example illustrated in FIG. 2, we can see that end user “nnnnn” was exposed to commercials for Restaurant Z and for the Amusement Park on Dec. 3, 2015. End user “nnnnn” conducted a payment transaction at the Amusement Park in the amount of $247.22 on Dec. 27, 2015 (only 24 days after exposure to the commercial). End user “nnnnn” also conducted a payment transaction at Restaurant Z on Dec. 28, 2015 (only 25 days after exposure to the commercial). These events alone or in combination with other stored data may provide Restaurant Z and the Amusement Park with interesting information.

In exemplary illustrations of the system 100, computer instructions cause the server computer 180 to direct particular content to an end user 120 based on the correlations. For example, server computer 180 may direct advertising server 170 to send particularized content to a particular user device 130 associated with particular ones of the end users 120 based on the correlations. The server 180 may also create pricing for such targeted ad delivery and allow advertisers to assess premium opportunities to reach particular end users 120 based on the correlation data and purchase such opportunities based on action and demographic data slices. In our example above, the information that Restaurant Z and the Amusement Park obtained from the system 100 may prompt these businesses to purchase particular advertising to be served to end users 120 of the system 100 via advertising server 170.

FIG. 3 illustrates an exemplary logic flow diagram 186 for the system 100 in accordance with one embodiment of the concepts set forth in the present application. As illustrated in step 187, the application 131 is downloaded or otherwise loaded onto a user device 130. As discussed above, the computer application 131 tracks the end user 120 performing one or more predetermined actions via their user device 130. The computer application 131—in association with server computer 180—offers the end user 120 a discrete incentive for performing the predetermined action. Those discrete incentives may include, for example, gift cards redeemable at movie theaters and stores. The computer application 131 may be downloaded onto the user device 130 during manufacture of the user device 130 or the end user 120 may be prompted to download the computer application 131 via an advertisement or as part of another offering. By way of non-limiting example, the computer application 131 may be a game, a browser, or any other type of application that may provide the end user 120 with functionality otherwise not found on their user device 130.

As shown in step 188, the system 100 populates the database 185 with demographic and payment information of end users 120. Once the computer application 131 is installed on the user device 130, the end user 120 creates a user account using uniquely identifiable information such as, for instance, a username and password combination which may be stored in the database 185.

When the user account is created, the system 100 generates a unique identifier to associate with the transactions and other activities of the end user 120 and user device 130. For instance, the unique identifier may be the login information, cookie, device ID, or system user ID. The unique identifier is not limited to these examples and may be any identifier used to track an end user on a digital platform. Over time, the monitoring of a set of transactions and action data associated with a unique identifier (e.g., the end user) allows the system to assess and predict the effectiveness of advertising on consumer behavior.

The end user 120 may input payment information 140 (e.g., at least one debit card or credit card) into the user device 130 or server computer 180 in order to link the payment information 140 to the unique identifier of the end user's 120 user account. After inputting of the payment information 140, transaction data will be pulled by the system 100—preferably in real time—from the transaction server 160 (e.g., a bank and/or a credit card company database associated with the debit card/credit card identified in the payment information 140). The payment information 140 and payment transaction data may be encrypted and decrypted by the system 100 and/or the transaction server 160. Any information provided to or transmitted by the user device 130 may be encrypted to secure end user 120 data.

In some embodiments, the account creation process may include a tutorial to teach the end user 120 how to add payment information 140 to their user account and authorize purchase transactions using the payment information 140 to be transmitted to the system 100, for instance, from the transaction server 160.

In one embodiment, the end user 120 may create a user account using a social media account. In such an embodiment, the system 100 will associate the social media account with the end user 120 such that the end user's 120 activity on social media will be associated with the end user's 120 user account of the system 100. In addition, the system 100 may be configured to use data from the social media account to populate the demographic and/or payment information of the end user 120.

In step 189, the database 185 receives action data from the computer application 131. As illustrated in FIG. 2, the action data identifies the end user 120 (“nnnnn” in FIG. 2) that transmitted the action data as well as the predetermined action performed. The action data is then stored in the database 185 associated with the end user's 120 user account.

In some embodiments, the system 100 will include step 190 in which the computer application 131 facilitates the predetermined action as described above prior to sending the action data to the database 185. In such an embodiment, the computer application 131 may be configured to cause the user device 130 to capture an image, or audio as shown in step 191. The computer application 131 associates the image and/or audio data with the action data which is then transmitted to the database 185.

Once the action data has been received in the database 185 as indicated in step 189, in some embodiments the system 100 will associate a time with the received action data as indicated in step 192.

The system 100 may also obtain payment transaction data (as indicated in step 193), for instance, from the transaction server 160. As described above, the payment transaction data will contain end user 120 payment information 140 such as, for instance, credit card or debit card information. In some embodiments, the system will associate a time with the obtained payment transaction data as indicated in step 194.

The system 100 will then find the end user's 120 user account associated with the payment information 140 in the payment transaction data and store the payment transaction data associated with the end user's 120 user account as indicated by step 195.

Once the action data and/or the payment transaction data have been associated with the end user's 120 user account, the system 100 may then distribute the incentive associated with the predetermined action performed to the end user 120 as indicated in step 196.

As shown in step 197, the system 100 correlates at least a portion of each of the end user demographic information, the end user action data, and the end user payment transaction data on an end user 120 by end user 120 basis to determine and assess consumer trends. This correlation information is used to create content based on the correlation as shown in step 198.

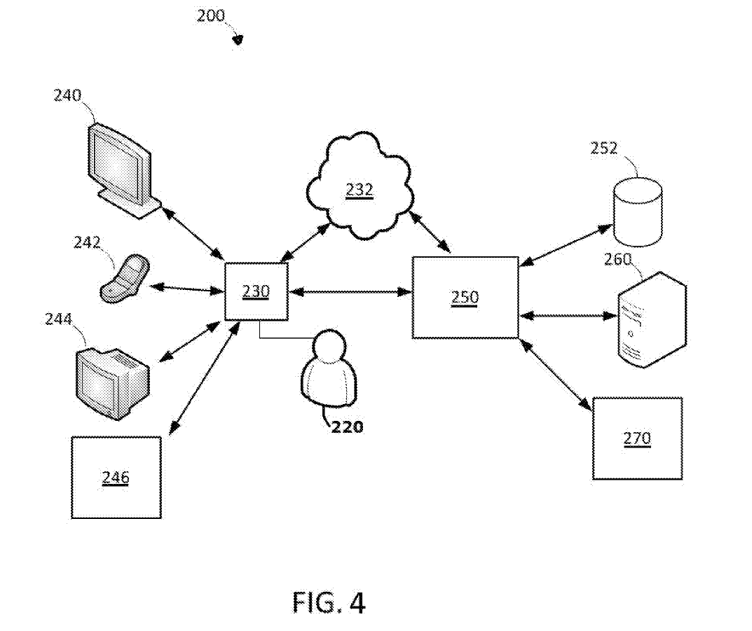

FIG. 4 illustrates a system 200 according to another exemplary implementation of the disclosed principles. An end user 220 and/or a user device 230 views, interacts, senses, and/or engages at least one advertisement over advertising media such as, for instance, a TV 240, a mobile device 242, a computer 244, or other advertising media 246 including an offline banner, display advertisement, billboard, poster, magazine, publication, mail, radio advertisement, advertisements within wearable technology and the like. It should be noted that the examples described are for the purposes of illustration only and should not be viewed as limiting. In using the system 200, the end user 220 may view, interact, sense, and/or engage any audio, visual, or audio/visual advertisement. It should be noted that the advertising media may include offline and online advertisements.

The user device 230 may be a mobile phone, wearable device, tablet, portable computer device such as a laptop or a desktop computer. The user device 230 may be bi-directionally connected to a server 250 via a data connection 232, which may be, for example, a cellular network connection, WiFi connection, wired connection, wireless connection, a local area network, or wide area network (e.g. the Internet). Recognition and detection of an advertisement may be provided through at least one sensor and any necessary processors and memory of the user device 230.

The user device 230 may detect an advertisement utilizing any number of sensors and processes including visual content recognition, audio content recognition (ACR), a QR code, other code identifier, PIN number, pass phrase, pass code, code word, or other specific human entered code. For instance, a camera in a mobile device may capture an image of a physical advertisement including a QR code for a predetermined web link. An image captured by a camera of the user device 230 may be analyzed to recognize particular shapes, codes, logos, keywords, numbers, features and other characteristics through optical character recognition and other image processing techniques to detect a predetermined advertisement.

In order to facilitate audio content recognition, the user device 230 may include a microphone or equivalent sensor for capturing audio and determining that the audio corresponds to an advertisement. Geolocation provided by, for instance, a GPS device may also be used to detect user engagement with an advertisement. The end user 220 may also input an acknowledgement of the advertisement into the user device 230 by any known input method or any analog scenario, such as by touch, voice, biometric input, and the like.

In one implementation, the system 200 can be implemented using a computer application (not shown) that can be downloaded onto a mobile device such as user device 230 and accessed by the user via the user device 230. The computer application is designed to cause the user device 230 to interact with the server 250 as disclosed herein. In another embodiment, the system 200 can be implemented via a website (e.g., “Perk.com”) located on the server 250 and accessible by the user device 230 over the data network 232. The user device 230 may be connected to the data network 232 as a delivery mechanism for the recognition of the advertisement and for obtaining the corresponding reward.

In operation of the system 200, the user 220 may activate the computer application on the user device 230 and then login to a reward program from the computer application running on the user device 230. Alternatively, the end user 220 may use any web-enabled device to log into the system 200 via the data network 232. The end user 220 may login through a social media account or by using other credentials (e.g., username and password) used to create their user account as described above. The end user's 120 activity such as profile information, advertisement acknowledgement information, and or other information related to the particular end user 220 is then associated with the user account. The user account information will also be used to allocate and track reward opportunities that the end user 220 has earned through acknowledging advertisements. The computer application may provide a login for existing end users 220 and a sign up process for acquiring new end users 220. The sign up process may include a tutorial to teach the end user 220 how advertisements are acknowledged by the user device 230. Some advertisements may include information directing the end user 120 to download the computer application. In one embodiment, the detecting of an advertisement by e.g., taking the image of a QR code, causes an account login and registration page to appear on the user device 230, allowing a new end user 220 to create an account at the same time the end user 220 acknowledged their first advertisement.

Once logged in, the end user 220 may input the advertisement acknowledgement or allow the user device 230 to detect the advertisements that the end user 220 engages or interacts with. The end user 220 may, for example, manually enter a code associated with a viewed advertisement on the user device 230. Alternatively, or additionally, the end user 220 may select an advertisement from a list of advertisements that offer reward opportunities. Advertisements provided on the user device 230 are also monitored by the computer application.

According to one embodiment disclosed herein, the user device 230 and user are provided within the vicinity of an advertisement so that the user device 230 can detect the advertisement using automatic content recognition including at least one of visual content recognition and audio content recognition.

Automatic content recognition provided by the user device 230 may operate continuously or during predetermined periods of time (set by the system 200 as a default time period, or by the end user 220 as a customized time period) to detect advertisements. The end user 220 may be provided with a notification that automatic content recognition is active and listening for qualified advertisements. For example, the automatic content recognition technology will respond to audio that is detected by the user device's 230 microphone. Any type of hardware, device, circuitry, software, or combination thereof, can be used to implement the automatic content recognition required to implement the presently disclosed inventive concepts. It should be appreciated that the automatic content recognition technology (including a microphone and camera in some examples) could be activated as soon as the end user 220 activates the computer application on the user device 230 or logs into the system 200.

The acknowledgement received/detected by the user device 230 is processed and then transmitted to the server 250. End users 220 may interface with the server 250 and execute portions of the disclosed method via a cellular network connection, WiFi connection, wired connection, wireless connection, and an Internet connection. The advertisement acknowledgement may be transmitted from the user device 230 via data network 232, radio or satellite, SMS or voice service, as well as a PUSH notification. The advertisement acknowledgement may be further transmitted by any messaging protocol such as email, for example. The system 200 can be accessed using social media such as e.g., Twitter, Facebook, and other social networking technology. In one embodiment, the end user 220 can call in the acknowledgement of the advertisement from a phone (using a phone number associated with the specific advertisement or the system) to an operator associated with the server 250 or system 200 in general.

The server 250 includes or is connected to a non-transitory memory for storing computer instructions required to implement the inventive concepts described herein and to store the various databases, user information and login/account verification algorithms used during the above-described processes as well as the rewards earned by the end user 220. The server 250 may include a database 252 for storing user account information, reward information, and profile information, as well as a database of advertisers and advertisements that may be acknowledged by a user to receive a reward. The server 250 can be accessed over a wired or wireless network (shown as the data network 232 in this example). The server 250 can include input/output devices such as mice, keyboards, displays, scanners, printers, etc. (not shown).

Once the advertisement is detected by the user device 230 and its acknowledgement is processed by the server 250, the server 250 generates and provides a reward for the end user 220. The benefits conferred upon the end user 220 upon acknowledgement of the advertisement are not particularly restrictive. As described above, rewards may include currency, physical goods, and virtual currency where the virtual currency may have real world value or only have virtual value. The end user 220 may be provided notification on their user device 230 or a web interface on the status of their reward.

The action data collected by the user device 230 may be stored in the database 252 and/or provided to other third party servers 260 for market research, tracking and analysis. Compensation may be provided by the advertiser/agency or proxy 270 for providing the rewards to the end user 220.

In one embodiment, the above described systems are implemented in software (i.e., computer instructions) that are stored in a tangible computer readable non-transitory memory and executed by at least one processor. Below is a description of a set of non-limiting use cases of the presently disclosed inventive concepts.

In one implementation, the end user 220 views a billboard (other advertisement 246) on the street with a code on it. The end user 220 then accesses the computer application on their user device 230 or calls a phone service and enters the code. The server 250 may include a call service center able to accept and process the end user's 220 phone call and code input. The end user 220 is then rewarded with a predetermined number of reward points.

In one implementation, the end user 220 sees an advertisement 246 at a bus stop with a QR code on it. The end user 220 photographs the QR code with a camera operably associated with the user device 230 and the QR code is recognized/processed by the computer application on the user device 230, which transmits an acknowledgement to the server 250, and the end user 220 is rewarded with a predetermined reward.

In one implementation, the end user 220 is driving and hears a radio commercial calling for certain action. The end user 220 opens the computer application on the user device 230, if not open already, and the computer application recognizes the audio of the advertisement and transmits an acknowledgement to the server 250 over the data network 232. The end user 220 is then provided with a predetermined reward.

In another implementation, the end user 220 watches TV 240 and once a qualified commercial appears on the TV 240, the computer application on the user device 230 recognizes the audio and/or video from the commercial and transmits an acknowledgement to the server 250. The end user 220 is then provided with a predetermined reward.

In yet another implementation, the end user 220 is wearing a wearable user device 230 such as Google Glass. The end user 220 watches a certain commercial on the TV 240 or sees a certain billboard/printed ad 246, which the wearable user device 230 detects prompting the computer application to transmit action data to the server 250, and the end user 220 is provided with a predetermined reward.

As disclosed herein, implementations and features consistent with the presently disclosed inventive concepts may be implemented through computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe components such as software, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

It should be appreciated that the disclosed principles are not limited to registered users of the network or users that login to the system disclosed herein. Accordingly, transactions and advertising may be tracked by any device regardless of whether the user or its device has an account with the network or system server. The user or its device may be identified based on a device ID, IP address or other form of identifier associated with the user or its device.

It should be appreciated that the disclosed processing provides a technical advancement over existing payment and advertising systems. Payment and action data associated with an end user 120, user device 130, login ID, etc. are correlated, manipulated and transformed so that it becomes possible to track, on a per user basis, e.g., purchasing habits in response to advertisements, etc. in a manner that is currently not possible without the disclosed principles. Some implementations of the innovations described herein solve a problem necessarily rooted in computer technology that does not provide advertisements to end users 120 that are effective in driving consumer purchases. The innovations provide a specific way to measure advertising effectiveness and/or provide targeted advertising to solve a problem faced by computing devices. In some implementations, the innovations effect a transformation of an advertisement or other form of advertising media (e.g., audio/video data or data stream) provided by a device (i.e., a particular article) to a different state or thing not achievable without the disclosed principles.

In another embodiment, analysis of the linked purchase transaction and offline/online action data allows subsequent advertising to be targeted based on the effectiveness of prior advertising or other advertising-like efforts. For example, effectiveness may be tracked by correlating data based on a specific advertisement served to the end user 120 on any device or article (e.g., TV, web, mobile, offline, billboard, poster, magazine, etc.) to purchases made with their payment credentials represented by the payment information 140 stored in their user account in the database 185. Analysis by the system 100 using server computer 180 may extrapolate data lift and advertising effectiveness down to the end user 120 level to generate a statistical reading on advertising effectiveness across a predetermined geography, advertising campaign, advertising unit, and so forth. Additionally, analysis of data gathered by these links generates insight into optimizing advertising for specific demographics.

The innovations discussed above may also be incorporated with an advertising recognition and acknowledgement aspects. For example, acknowledgement/recognition of an advertisement by the end user 120 may generate an additional reward when the end user 120 makes a purchase with their linked credit card or debit card, electronic payment service (e.g., PayPal), or scanned-in receipt for a cash or other payment, since the recognition of the advertisement is now tied to the purchase made as well. Providing a reward to the end user 120 further encourages the end user 120 to make purchases based on advertisements presented to them.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A method comprising:
causing a computer application to be downloaded onto a user device, the computer application tracking an end user performing a predetermined action via the user device, the computer application in association with a server computer offering the end user a discrete incentive for performing the predetermined action;
populating a database with demographic and payment information of end users associated with the server computer, the database being operably associated with the server computer;
receiving, at the database, action data from the computer application associated with each predetermined action, the action data identifies the user device that transmitted the action data and the predetermined action;
obtaining payment transaction data associated with the payment information of the end users;
storing the obtained payment transaction data in association with the server computer;
correlating, by the server computer, at least a portion of each of the end user demographic information, the end user action data, and the end user payment transaction data on an end user by end user basis; and
creating content based on the correlation.

2. The method of claim 1 further comprising:
associating a time for each end user action data and each end user payment transaction data received at the database;
further correlating by the server computer based on relative time at least a portion the end user action data and the end user payment transaction data on an end user by end user basis.

3. The method of claim 3 further comprising enabling the end user to perform the predetermined action via the computer application, the predetermined action being selected from the group comprising downloading the computer application, making a purchase, playing a game, capturing an image of a receipt corresponding to a purchase, watching at least a predetermined amount of a video, listening at least a predetermined amount of a program, accessing a website, participating in a survey, acknowledging receipt of particular electronic content, taking a photo, and taking a video.

4. The method of claim 3 wherein the predetermined action is listening to at least a predetermined amount of a program, user device having a microphone and the computer application is capable of capturing audio via the microphone, the action data further provides data associated with the captured audio from the program, the method further comprising identifying the program from the data associated with the captured audio.

5. The method of claim 4 wherein the program is an advertisement, the method further comprising storing identifying information for the advertisement in the database in association with the action data; and correlating further comprises looking for a temporal relationship between the advertisement and the obtained payment transaction data.

6. The method of claim 5 further comprising prompting distribution of the discrete incentive for performing the predetermined action via the server computer.

7. The method of claim 6 further comprises prompting distribution of another discrete incentive to the end user based on the correlation of the at least a portion of each of the end user demographic information, the end user action data, and the end user payment transaction data on an end user by end user basis.

8. The method of claim 7 wherein the discrete incentive is selected from the group comprising discount coupons, gift cards, cash, currency, vouchers, tangible goods, virtual goods, videos, and access to premium content.

9. The method of claim 8 further comprising receiving, at the database, action data from the computer application associated with a non-predetermined action, the action data identifies the user device that transmitted the action data and the non-predetermined action.

10. A system comprising:
a server computer operably associated with one or more user devices such that the server computer receives information from the user devices indicative of an end user performing a predetermined action via the user device;
a database operably associated with the server computer, the database being configured to store demographic and payment information of end users of associated with the server computer, the database being further configured to receive action data from the one or more user devices associated with each predetermined action performed on that user device, the action data identifies the user device that transmitted the action data and the predetermined action;
means, operating in association with the computer server, for obtaining payment transaction data associated with the payment information of the end users and storing the obtained payment transaction data in association with the server computer; and
means, operating in association with the computer server, for correlating at least a portion of each of the end user demographic information, the end user action data, and the end user payment transaction data on an end user by end user basis.

11. The system according to claim 10 further comprising means for associating a time for each end user action data and each end user payment transaction data received at the database, wherein the means for correlating further correlating based on relative time at least a portion the end user action data and the end user payment transaction data on an end user by end user basis.

12. The system according to claim 11 wherein the predetermined action is selected from the group comprising downloading the computer application, making a purchase, playing a game, capturing an image of a receipt corresponding to a purchase, watching at least a predetermined amount of a video, listening at least a predetermined amount of a program, accessing a website, participating in a survey, acknowledging receipt of particular electronic content, taking a photo, and taking a video.

13. The system according to claim 12 wherein the predetermined action is listening to at least a predetermined amount of a program, the action data further includes data associated with audio captured from the program, the system further comprising means for identifying the program from the data associated with the captured audio.

14. The system according to claim 13 wherein the program is an advertisement, the database further containing information regarding the advertisement in association with the action data; and the means for correlating further looks for a temporal relationship between the advertisement and the obtained payment transaction data.
